(19) United States
(12) Patent Application Publication
(10) Pub. No.: US 2023/0264728 A1
(43) Pub. Date: Aug. 24, 2023

(54) TRAIL BUDDY

(71) Applicant: Thomas Reilly, Tucson, AZ (US)

(72) Inventor: Thomas Reilly, Tucson, AZ (US)

(21) Appl. No.: 17/675,158

(22) Filed: Feb. 18, 2022

(51) Int. Cl. B62B 1/14

(52) U.S. Cl. CPC B62B 1/14; B62B 2202/24

(57) ABSTRACT

A carrier for bring supplies on a hiking or backpacking excursion is presented. The carrier has a first side, a top portion a bottom portion, a top side and a bottom side. The top portion being hindgely coupled to the bottom side. There is an interior of the bottom portion for storing supplies and an inset of the top portion for allowing oversized supplies. The carrier may have a coupling for coupling the top portion to the bottom portion and a plurality of locking straps for securing the closure of the top portion and bottom portion. There may also be security straps which may wrap around the carrier for further secure coupling of the top portion and bottom portion. A transport cart is also shown which can be used to easily and efficiently transport the carrier from one location to a different location.

### FIELD OF THE INVENTION

This invention relates to emergency supplies. More particularly, it relates to an apparatus for bring emergency supplies on a trail.

### BACKGROUND

Outdoor people enjoy hitting the trail and making a day of viewing the beautiful scenery and getting exercise. These people often “hit the trail”, that is either going backpacking or hiking. Often exercise, view of the scenery or basic enjoyment of company on the trail are the basis for the activity.

Backpacking is the outdoor recreation of carrying gear on one’s back, while hiking for more than a day. It is often but not always an extended journey, and may or may not involve camping outdoors. In North America tenting is common, where simple shelters and mountain huts widely found in Europe are rare. In New Zealand, tramping is the term applied though overnight huts are frequently used. Hill walking is an equivalent in Britain (but this can also refer to a day walk), though backpackers make use of all kinds of accommodation, in addition to camping. Backpackers use simple huts in South Africa. Similar terms used in other countries are trekking and bushwalking.

Backpacking as a method of travel is a different activity, which mainly utilizes public transport during a journey which can last months.

Hiking is the preferred term, in Canada and the United States, for a long, vigorous walk, usually on trails (footpaths), in the countryside, while the word walking is used for shorter, particularly urban walks. On the other hand, in the United Kingdom, and the Republic of Ireland, the word “walking” is acceptable to describe all forms of walking, whether it is a walk in the park or backpacking in the Alps. The word hiking is also often used in the UK, along with rambling (a slightly old-fashioned term), hillwalking, and fell walking (a term mostly used for hillwalking in northern England). The term bushwalking is endemic to Australia, having been adopted by the Sydney Bush Walkers club in 1927. In New Zealand a long, vigorous walk or hike is called tramping. It is a popular activity with numerous hiking organizations worldwide, and studies suggest that all forms of walking have health benefits.

Backpacking gear begins with (1) a suitable backpack, proper both in size and fit. Backpacks in general fall into one of four categories: frameless, external frame, internal frame, and bodypack. (2) Clothing and footwear appropriate for expected conditions. (3) Adequate food. (4) Some form of sleep system such as a sleeping bag and, perhaps, a foam pad. (5) Survival gear.

A shelter appropriate to expected conditions is typically next. Practical items not already mentioned - cook kit, stove, container for water, a means of purifying it - are characteristically but not always taken in some form. Depending on the trip ready-to-eat foods may suffice and suitable water be found along the way. More minimalist backpackers find ways to do with less.

Weight is always critical. A rule of thumb suggests a fully loaded backpack should weigh no more than 25% of a person’s weight. Every single item is scrutinized, many removed the first time a pack is hefted. Lightweight gear is widely available, which may or may not sacrifice utility and durability but will almost always cost more. A wide variety utilizing carbon fiber, lightweight alloys, specialty plastics, and impregnated fabrics is available.

The equipment required for hiking depends on the length of the hike, but day hikers generally carry at least water, food, a map, and rain-proof gear. Hikers usually wear sturdy hiking boots for mountain walking and backpacking, as protection from the rough terrain, as well as providing increased stability. The Mountaineers club recommends a list of “Ten Essentials” equipment for hiking, including a compass, a trekking pole, sunglasses, sunscreen, a flashlight, a first aid kit, a fire starter, and a knife.^{[24]} Other groups recommend items such as hat, gloves, insect repellent, and an emergency blanket. A GPS navigation device can also be helpful and route cards may be used as a guide.

Proponents of ultralight backpacking argue that long lists of required items for multi-day hikes increases pack weight, and hence fatigue and the chance of injury. Instead, they recommend reducing pack weight, in order to make hiking long distances easier. Even the use of hiking boots on long-distances hikes is controversial among ultralight hikers, because of their weight.

Hiking times can be estimated by Naismith’s rule or Tobler’s hiking function, while distances can be measured on a map with an opisometer. A pedometer is a device that records the distance walked.

Whether hiking or backpacking, getting lost is sometimes inevitable. Many hikers and backpackers do not have the foresight to have supplies to help them in case of getting lost or don’t have the means to transport the supplies. Therefore, there is a need to have an apparatus for easily and efficiently bringing life saving supplies while hiking or backpacking.

### BRIEF DESCRIPTION OF THE DRAWINGS

FIG. 1A is an illustrated view of an exemplary carrier on a two-wheel truck.

FIG. 1B is an illustrated view of an exemplary carrier shown in FIG. 1A on a pull dollie.

FIG. 2 is an illustrated view of an interior of the carrier shown in FIG. 1A.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

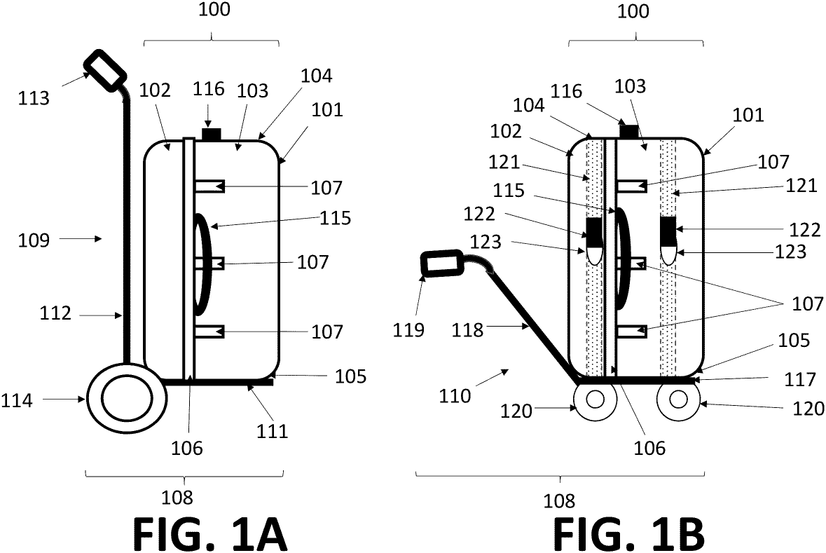

Referring to FIGS. 1, a carrier 100 for carrying emergency supplies and other supplies on a hike or backpacking trek. The carrier 100 is useful to easily carry supplies including emergency supplies while hiking or backpacking on trails. In the event of the hiker/backpacker getting lost, the emergency supplies could be lifesaving.

The carrier 100 preferably has a height of twenty-two (22) inches, but other heights may be used when desired and transportable. The carrier 100 preferably has length of fourteen (14) inches, but the length may be any length desirable. The carrier 100 preferably has a width of seven and one-half (7.5) inches, but the width may be any width desirable. The carrier preferably has a shape being rectangular, but the shape may be any shape such as square, oblong, trapezoidal, etc.

The carrier 100 has a first side 101, a top portion 102, a bottom portion 103, a top side 104 and a bottom side 105. The bottom side 105 of the carrier 100 has storage area for supplies. The supplies may be container of water, balloons, a helium tank, a kit string, a balloon regulator nozzle, a blanket, a first aid kit, a compass, etc.

The top portion 102 of the carrier 100 is hingedly coupled to the bottom portion 103 of the carrier 100 by a coupling 106. The coupling 106 preferably has a hinge, but the coupling may come completely apart, etc. The hinge of the coupling 106 is preferably on a back side (not shown) of the carrier 100.

The coupling 106 has a plurality of locking straps 107. The locking straps 107 are for securely coupling the top portion 102 of the carrier 100 to the bottom portion 103 of the carrier 100 when the carrier 100 is in a closed condition. The locking straps 107 being on the first side 101 of the carrier 100. The locking straps 107 may further have a lock (not shown).

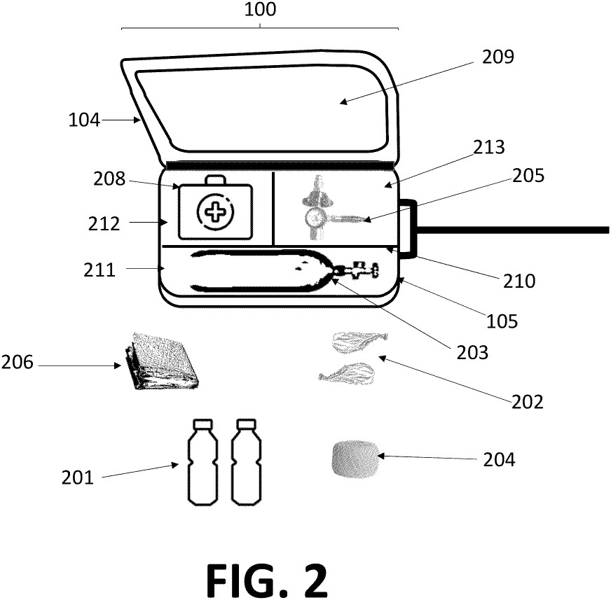

The carrier 100 may further have a transport cart 108. The transport cart 108 may be a two-wheel truck 109 of FIGS. 1, a dollie 110 of FIG. 2., etc. The transport cart 108 is useful in providing an apparatus to easily and efficiently move the carrier 100 without excessive exertion by the hiker or backpacker.

The two-wheel truck 109 has a platform 111, an arm 112, a handle 113 and a plurality of wheels 114. The bottom side 105 of the carrier 100 is placed on the platform 111 of the two-wheel truck 109. The hiker/backpacker takes a hold of the handle 113 and pulls back and down on the handle thus pulling the arm 112 toward the ground. The platform 111 and thus the carrier 100 is raised off of the ground and by pulling or pushing the two-wheel truck 109, the wheels 114 move in a direction determined by the pushing or pulling and the carrier 100 is moved towards a destination.

Optionally and or additionally, the carrier may have a first handle 115 and a second handle 116. The first handle 115 is coupled to the first side 101 of the carrier 100 for picking the carrier 100 up. The second handle 116 is coupled to the top side 104 of the carrier 100.

Moving now to FIG. 1B, the carrier 100 shown in FIGS. 1 is coupled to the dollie 110.

The dollie 110 has a platform 117, an arm 118, a handle 119 and a plurality of wheels 120. The bottom side 105 of the carrier 100 is placed on the platform 117 of the dollie 110. The hiker/backpacker takes a hold of the handle 119 and by pulling or pushing the dollie 110, the wheels 120 move in a direction determined by the pushing or pulling and the carrier 100 is moved towards a destination.

Optionally and/or additionally, to further secure the carrier 100, the carrier may have security straps 121. The security straps 121 may be useful in adding additional coupling and securing of the top side 104 of the carrier 100 to the bottom side 105 of the carrier 100. Further, the security straps may be coupled to the platform 111, 117 of the transport cart 108.

The security straps 121 have a connector 122 and a locking clip 123. The security straps 121 are placed completely around the carrier 100 and optionally coupled to the platform 111, 117 of the transport cart 108. The security straps 121 are coupled at the connector 122. The connector 122 can be adjusted to make the security straps 121 taut. The locking clip 123 is coupled to the connector 122 of the security straps 121. The locking clip 123 is set such that the connector 122 does not become “loose” and the security straps 121 become un-taut, thus un-securing the carrier 100.

Referring now to FIG. 2, an interior 200 of the carrier 100 is shown. The interior 200 of the carrier 100 is useful for storing the supplies necessary or desired to be taken on the hike/backpacking trek. The supplies may include water bottle 201, balloons 202, a helium tank 203, a kite string 204, a balloon regulator nozzle 205, a blanket 206, first aid kit 208, etc.

The top portion 104 of the carrier 100 has an inset 209. The inset 209 is useful for allowing space for oversized supplies stored in the carrier 100.

The bottom portion 105 of the carrier 100 is preferably larger in space than the top portion 104 of the carrier 100. The bottom portion 105 of the carrier has a cavity 210.

The cavity 210 is useful for placing and storing supplies to be taken on a trail hike or backpacking. The cavity 210 may have a plurality of tiers (not shown) which are useful for stacking supplies securely and safely on top of each other thus better utilizing the space available in the bottom portion 105 of the carrier 100.

The cavity 210 may have one or more compartments 211, 212, 213. The one or more compartments 211, 212, 213 are useful for safely stowing supplies such that each of the supplies will not be affected by the others.

A first of the one or more compartments 211 is useful for storing longer supplies such as the helium tank 203.

A second of the one or more compartments 212 has less area than the first of the one or more compartments 211. The second of the one or more compartments 212 is useful for storing supplies such as the first aid kit 208.

A third of the one or more compartments 213 has less area than the first of the one or more compartments 211 but is substantially the same size as the second of the one or more compartments 212. The third of the one or more compartments 213 is useful for storing supplies such as the balloon regulator nozzle 205.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A carrier for bring supplies on a hiking or backpacking excursion, comprising:
a first side, a top portion a bottom portion, a top side and a bottom side;
the top portion being hindgely coupled to the bottom side;
a coupling, the coupling being coupled to the top portion and the bottom portion;
a locking strap, the locking strap being coupled to the coupling for further securing the carrier;
an interior of the bottom portion, the interior of the bottom portion for storing supplies; and
an inset of the top portion, wherein the inset of the top portion being for allowing oversized supplies.

2. The carrier of claim 1, wherein the carrier having a height of twenty-two (22) inches.

3. The carrier of claim 1, wherein the carrier having a length of fourteen (14) inches.

4. The carrier of claim 1, wherein the carrier having a width of seven and one-half (7.5) inches.

5. The carrier of claim 1, further comprising:
the interior of the bottom portion having one or more compartments, wherein the one or more compartments for isolating supplies.

6. The carrier of claim 5, wherein the one or more compartments being the same size.

7. The carrier of claim 1, further comprising:
a transport cart, for transporting the carrier;.

8. The carrier of claim 8, wherein the transport cart being a dollie.

9. The carrier of claim 8, wherein the transport cart being a two-wheel truck.

10. The carrier of claim 1, further comprising:
one or more security straps, the security straps for securing the closure of the top portion and the bottom portion;
a connector, the connector for connecting the one or more security straps, wherein the connector making the one or more security straps taut around the carrier; and
a locking clip, the locking clip coupled to the connector, wherein the locking clip preventing the one or more security straps from becoming loose.

11. The carrier of claim 1, wherein the supplies being a helium tank.

12. The carrier of claim 1, wherein the supplies being a blanket.

13. The carrier of claim 1, wherein the supplies being a balloon regulator nozzle.

14. The carrier of claim 1, wherein the supplies being one or more water bottles.

15. The carrier of claim 1, wherein the supplies being kite string.

16. The carrier of claim 1, wherein the supplies being a compass.
